(19) United States
(12) Patent Application Publication
(10) Pub. No.: US 2006/0005227 A1
(43) Pub. Date: Jan. 5, 2006

(54) Languages for expressing security policies

(75) Inventors: Anders Samuelsson, Redmond, WA (US); Thomas Fakes, Redmond, WA (US); Arindam Chatterjee, Issaquah, WA (US); Art Shelest, Sammamish, WA (US); Mark Vayman, Redmond, WA (US); Rajesh Dadhia, Redmond, WA (US); Saveen Reddy, Redmond, WA (US); Shirish Koti, Redmond, WA (US); Steven Townsend, Seattle, WA (US)

Correspondence Address: PERKINS COLE LLP/MSFT, P. O. BOX 1247, SEATTLE, WA, 98111-1247, US

(73) Assignee: Microsoft Corporation, Redmond, WA (US)

(21) Appl. No.: 10/882,438

(22) Filed: Jul. 1, 2004

(51) Int. Cl. G06F 17/00

(52) U.S. Cl. 726/1

(57) ABSTRACT

Languages for expressing security policies are provided. The languages comprise rules that specify conditions and actions. The rules may be enforced by a security engine when a security enforcement event occurs. The languages support data separation, dynamic evaluation, and ordered rule scope. By separating data from logic, security engines may only need to be updated with a portion of rules that change. With dynamic evaluation, expressions of rules may be evaluated dynamically, such as by querying a database, when a security engine enforces a rule. With ordered rule scope, when a security enforcement event implicates a number of rules simultaneously, the rules may be enforced in a deterministic and logically organized manner.

### TECHNICAL FIELD

The described technology relates generally to operating systems and, more particularly, to languages for expressing security policies.

### BACKGROUND

Users of application programs or operating systems sometimes inadvertently install software resources that misbehave or are malicious. Software resources include, e.g., application programs, user interfaces, device drivers, network protocol stacks, and other electronic information. As an example, users may install an application program that provides desirable functionality but may be infected with a virus that produces undesirable results. As a further example, the installed application program may be a Trojan horse. A Trojan horse is a program that provides useful functionality and otherwise appears to be innocuous, but may be malicious or provide unintended results. Indeed, any software resource may inadvertently behave in unintended ways because of programming errors, conflicts with other software resources, or a variety of other reasons.

When a software resource misbehaves or performs malicious activities, it may cause a variety of problems for users, other software resources, and an operating system that may be managing and coordinating multiple software resources. Techniques designed to prevent these problems by securing applications and operating systems are described in commonly assigned co-pending patent application Ser. No. 10/836,810, entitled “SECURING APPLICATIONS AND OPERATING SYSTEMS,” which is hereby incorporated herein in its entirety by reference. The following discussion provides an overview of the technology described in this co-pending patent application, and is not to be construed to be prior art to this application. In an embodiment of the technology disclosed in the co-pending patent application, a security engine enforces security policies that help to ensure that a vulnerability of the operating system cannot be exploited. A security policy comprises indications of security enforcement events and security enforcement actions. A security enforcement event is an event for which a security policy is defined. As examples, security enforcement events could be sending or receiving a certain type of message at a network port, a request to modify an executable file, and a request to format a hard disk. A security enforcement action is an action specified in a security policy relating to the security enforcement event. As examples, security enforcement actions may include, e.g., allowing the event, denying the event, notifying a user, or requesting input from a user. Examples of security enforcement actions taken by security engines include, but are not limited to, protection against electronic viruses, authorization of network access, detection of intrusion by unauthorized users or software resources, detection of outdated software resources, automatic “lockdown” of software resources (e.g., in response to a signal from an administrator), and general blocking of undesirable behavior by users and software resources.

The security engines may receive security policies as documents from a host services component. It would be highly desirable to provide a common language for expressing security policies that can be enforced by security components.

### SUMMARY

Languages for expressing security policies are provided. The languages comprise rules that specify conditions and actions. The rules may be enforced by a security engine when a security enforcement event occurs. The languages support data separation, dynamic evaluation, and ordered rule scope. By separating data from logic, security engines may only need to be updated with a portion of rules that change. With dynamic evaluation, expressions of rules may be evaluated dynamically, such as by querying a database, when a security engine enforces a rule. With ordered rule scope, when a security enforcement event implicates a number of rules simultaneously, the rules may be enforced in a deterministic and logically organized manner.

### BRIEF DESCRIPTION OF THE DRAWINGS

FIG. 1 is a block diagram illustrating components of a system having a language for expressing security policies in an embodiment.

FIG. 2 is a block diagram illustrating components of a system having a language for expressing security policies in a security policy document in an embodiment.

FIG. 3 is a block diagram illustrating components of a system having a language for expressing security policies with dynamic expression evaluation in an embodiment.

FIG. 4 is a block diagram illustrating a security policy document in an embodiment.

### DETAILED DESCRIPTION

Languages for expressing security policies are provided. The languages comprise rules that specify conditions and actions. As an example, a rule may indicate that an application may not receive messages on any network port other than port 80. The condition of the rule may detect that a message was received on a network port other than port 80, and the action may be to discard it. As a further example, a rule may indicate that when an application attempts to send a message on network port 8080, authorization is to be solicited from a user of the computing system on which the rule is enforced.

Rules may be categorized into rule types based on the type of their behavior. As an example, a network security rule type may comprise a set of rules implementing network security, such as whether applications can send or receive messages on an indicated network port. In an embodiment, a rule type may relate to rules of a security engine that enforces security policies.

A rule comprises a condition, an action, and optionally an exception. The condition, action, and exception may be expressed as expressions. A rule may be semantically expressed as “IF conditions THEN actions EXCEPT exceptions.” Conditions of a rule are an expression of circumstances under which security enforcement actions of the rule could be performed. An action is an expression of activity to be performed when the condition is satisfied. A rule may have multiple actions. An exception is an expression of when the actions may not be performed even though the condition is satisfied. A condition may be either static or dynamic. A static condition is one which refers, e.g., to a hard-coded list of files. A dynamic condition is one which, e.g., performs a query to determine a list of files matching provided criteria. An action comprises activities that a security engine may perform when a condition is satisfied. As an example, when a security enforcement event is listed in a condition of a rule, a security enforcement action relating to the rule could be performed. An exception may comprise a list of software resources for which, e.g., the security enforcement action may not be taken. The action may not be performed for an application when the application is listed as an exception. Security enforcement actions could be, e.g., to allow a request that caused the security enforcement event, to deny the request, to solicit input from a user, to notify the user, etc. Other rule constructs are also possible. As an example, an else construct could be added to perform alternate actions when a condition is false.

In an embodiment, the languages support ordering of rules. When rules are ordered, it may be possible to determine which of a subset of rules will provide a security enforcement action relating to a security enforcement event that implicates multiple rules. As an example, when a first rule indicates that no application is to write to network port 8080 and a second rule indicates that when an Internet browsing application attempts to write to port 8080, user approval should be sought, it would be beneficial to order the rule relating to the Internet browsing application first because it would have no effect if ordered second as the first rule may result in the write being canceled.

In an embodiment, the languages support specification of a default action relating to security policies and rules. When a security policy is defined by a number of rules and a security enforcement event does not implicate any of the conditions of the rules, a default action may be indicated. As an example, when a set of rules indicates to which folders a provided list of applications may write data, a default action may be provided relating to a temporary folder to which any application may be allowed to write data.

In an embodiment, the languages may be expressed in a variety of forms including, e.g., an extensible markup language (“XML”), plain text, binary files, or any electronic file format. When XML is used, the languages may be described using an XML schema language such as XML Schema Definition language or Document Type Definitions.

As described above, the security policy languages support data separation, dynamic security expression evaluation, and ordered rule scope. Further details relating to these features of the languages are provided below.

Data Separation

In an embodiment, a security policy document (“policy document”) is expressed in a language that separates data and rules into definitions and rules sections, respectively. The definitions section comprises data that may be used by rules. The definitions section may, e.g., have an identifier associated with a list, and the list may comprise a set of names of software resources. As an example, the definitions section may contain a list named $BAD_APPS that lists applications TROJAN.EXE and INFECTED.EXE.

The rules section comprises expressions relating to rules of a security policy. As an example, the rules section may have a rule indicating that some software resources are to be denied any ability to send or receive network messages. Expressions associated with rules may refer to data in the definitions section. An expression is a portion of a condition or action associated with a rule that may be evaluated when a security engine processes a security enforcement event. Continuing the prior example, a rule may reference the identifier for the list of software resources, such as in the following manner:

<network_rules>

<conditions>

<ports>ALL</ports>

</conditions>
<actions>

<deny>

<application>$BAD_APPS</application>

</deny>

</actions>

</network_rules>

A security engine may enforce this rule when a software resource requests to send a message on a network or the operating system receives a message from the network, and thereby generates a security enforcement event. Upon determining that this security enforcement event has occurred, the security engine may determine whether the application sending or receiving the message is listed in the set of applications defined by the $BAD_APPS identifier (i.e., TROJAN.EXE or INFECTED.EXE). If that is the case, the message will not be forwarded (i.e., the operation to send or receive the message would be denied).

By separating definitions from rules, the definitions and the rules may be updated independently. As an example, a newly discovered Trojan horse can be added to the list of applications that should be unable to access operating system resources. When this is done, it may be possible to update a security policy document for a security engine with a smaller amount of data than would be possible if data and rules are updated together. Moreover, when multiple rules reference an identifier, the space savings could be compounded because an identical data set (e.g., list of applications) may not need to be listed multiple times.

Dynamic Security Expression Evaluation

In an embodiment, conditions or actions of rules may comprise security expressions that are dynamically evaluated when a security enforcement event occurs. An expression of a security condition or action may be expressed as a query. Queries may be used, e.g., to dynamically determine which resources should be allowed to send or receive network messages. The query may be expressed in a variety ways including, e.g., using a structured query language (“SQL”) or Windows Management Instrumentation Query Language (“WQL”). Other query forms may also be used, e.g., to query a registry or metabase. As an example, a security policy may indicate to allow network access when an Internet Protocol (“IP”) address of a computing system that is evaluating the security policy is known by a network directory service, such as MICROSOFT ACTIVE DIRECTORY. Then, when a security event relating to network access occurs, the security engine may dynamically evaluate the expression by querying the directory service to determine whether the computing device's IP address is listed, which may be an indication that the computing device is allowed to send or receive network messages. To add or remove computing devices, a network administrator may only need to update the directory service. Thus, the effect of a security condition or action may be manipulated outside the security system when security expressions are evaluated dynamically.

Ordered Rule Scope

In an embodiment, a language for expressing security policy documents may identify rules in multiple rule scopes. Scopes may define logical groupings for rules and may be used to determine to which security engines the rules in the security policy document should be provided, and in which order the rules should be enforced. Scopes may be defined at various levels, and these levels may have a hierarchical relationship. As an example, scopes may be defined at an application level, execution level, and protection level, and each application level may have an execution level, and each execution level may have a protection level. An application-level scope may identify all rules associated with a software resource. As examples, application-level scopes may be indicated for a network protocol stack, web browser application, word processing application, and a database application. An execution-level scope may identify rules associated with an execution context of an application. As an example, a web-browsing application may have execution-level scopes for its hypertext transfer protocol, file transfer protocol, and “telnet” execution contexts. Each execution-level scope may have one or more protection-level scopes. A protection-level scope identifies whether a rule is global, resource-specific, or default. When a rule is global, the rule applies to a number of identified software resources. An administrator may be able to modify the list of identified software resources. When a rule is resource-specific, the rule may be enforced when an identified resource caused a security enforcement event relating to the rule. When a rule is default, the rule may apply to all software resources not specifically identified in the resource-specific rules. The global rules may be evaluated before the resource-specific rules, which may be evaluated before the default rules. Alternatively, an administrator or the security system may indicate an order for rule evaluation. By defining and organizing rules into scopes, when a security enforcement event implicates a number of rules simultaneously, the rules may be enforced in a deterministic and logically organized manner.

In an embodiment, ordered rule scope may be used to determine which rules a security engine could receive for enforcement. A scope level may indicate that a subset of rules is to be applied when a condition is true. This subset of rules may be sent to security engines when this condition is true. Examples of conditions may include, e.g., determining whether installed software is up-to-date by using tools that provide such information such as MICROSOFT WINDOWS UPDATE SERVICE, or determining whether a software resource is installed. As further examples, when a security patch is not installed, various network ports may be disabled, or when a software resource is not installed, rules relating to the software resource can be ignored. As a specific example, when MICROSOFT INTERNET INFORMATION SERVICE (“IIS”) is installed on a computing device but its File Transfer Protocol (“FTP”) is disabled, rules relating to IIS may be enforced except for a subset of rules defined in a FTP protection level scope. Thus, security engines may use different subsets of rules depending on whether the patch or software resource are installed. Subsets of rules that may be used by a security engine may be defined by a scope level, such as protection level scope.

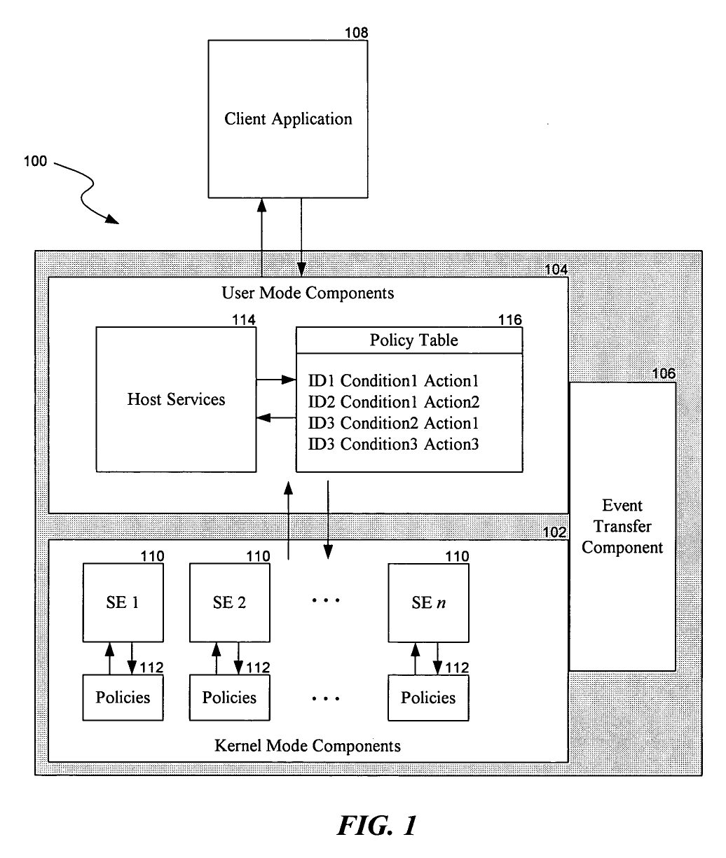

Turning now to the Figures, FIG. 1 is a block diagram illustrating components of a system having a language for expressing security policies in an embodiment. The system comprises kernel mode components 102, user mode components 104, an event transfer component 106 for transferring events from the kernel mode components to user mode components such as an Event Tracing for WINDOWS component and a client application program 108. The component for transferring events can operate asynchronously or synchronously. Components other than Event Tracing for WINDOWS can be used for communications between user mode and kernel mode components including, e.g., application program interface calls, sockets, etc. The system also includes security engines 110 and related policy tables 112. Each policy table contains rules referenced by a security engine. Alternatively, the security engines may all use one policy table or several policy tables and, in such a case, the table(s) would identify which security engine(s) each policy is for. The system further includes a host services component 114 and a related security policy table 116. The kernel mode components, user mode components, and event transfer component are all contained in an operating system 100.

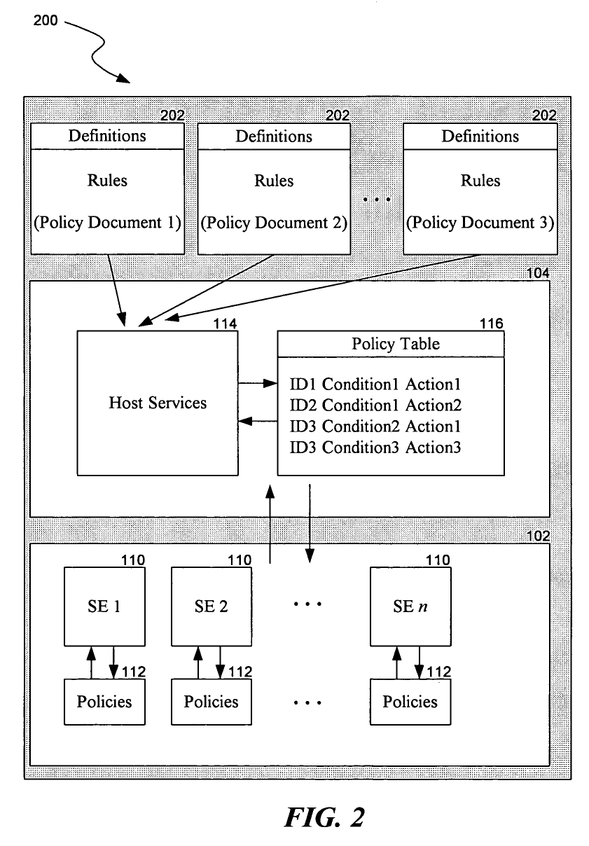

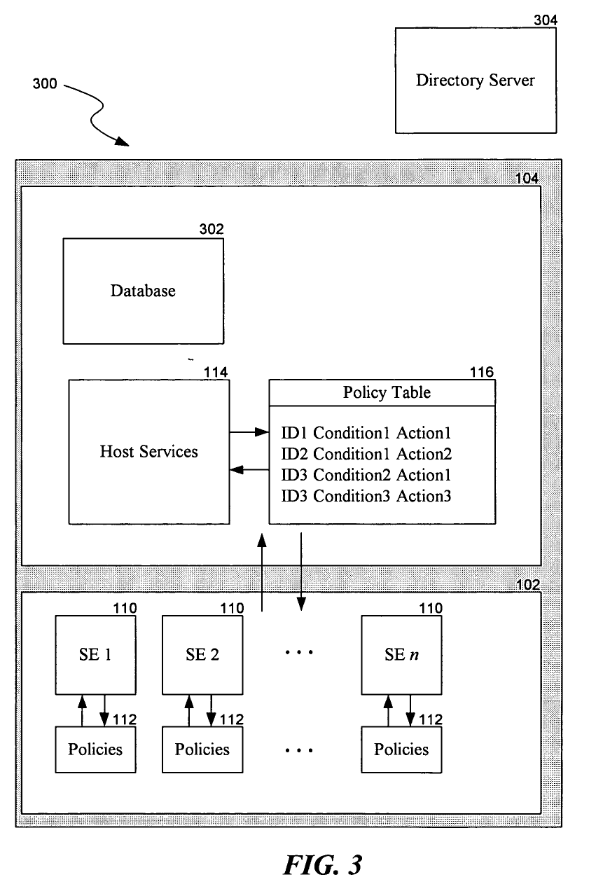

FIGS. 2-3 illustrate additional components of the system of FIG. 1. For simplicity, some components are neither illustrated nor described in FIGS. 2-3, such as the event transfer component 106.

FIG. 2 is a block diagram illustrating components of a system having a language for expressing security policies in a security policy document in an embodiment. A computing system 200 comprises components as illustrated and described above in relation to FIG. 1. The host services component 114 of the computing system may utilize policy documents 202 to create policies 112 for the security engines 110.

The host services component may load the security policy documents. Loading a policy document may involve retrieving a policy document from storage, determining policies from its contents, and sending to each security engine policies relevant to the security engine. The policy documents may be stored at the computing system or at another computing system, such as a server (not shown). Alternatively the host services component may expose an application program interface (“API”) (not shown) through which it is provided policy documents. In an embodiment, the host services component may be notified, e.g., through its API, to retrieve a policy document, such as an updated document. In an embodiment, the host services component detects that a policy document it has previously loaded has been updated. The host services component may determine a new policy document is available and load it automatically. To determine whether a policy document has changed or a new security policy document is available, the host services component may utilize services exposed by an operating system (e.g., file creation or change notifications) or database server in which security policy documents may be stored (e.g., triggers that are performed with adding or changing rows).

After loading a security policy document, the host services component may determine to which security engine each rule indicated in the security policy document should be sent. The host services component may then update the security engine with the relevant rule(s), and may also store the rules in the policy table 116.

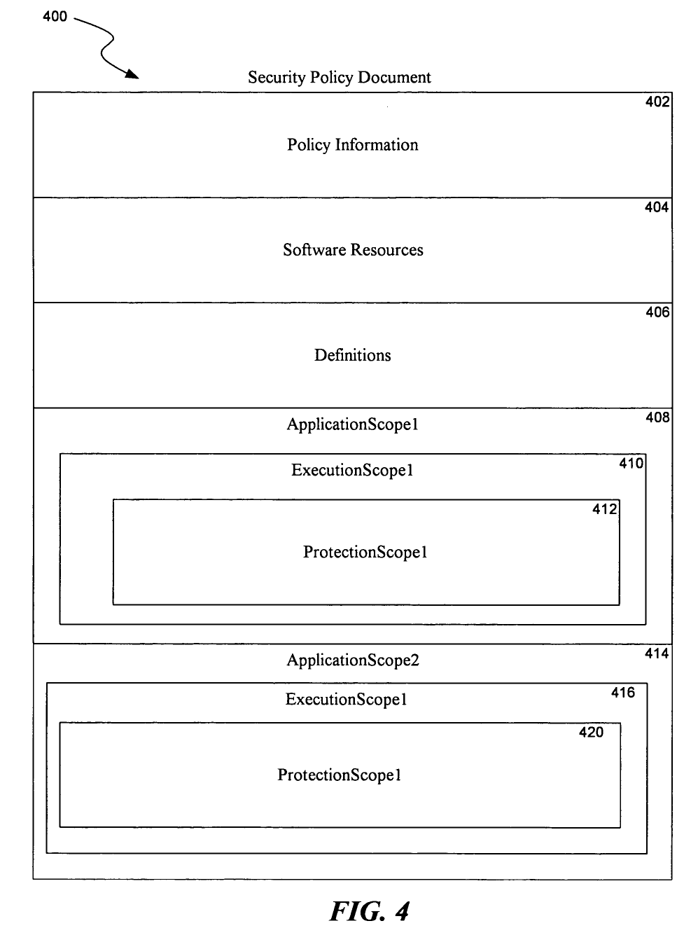

FIG. 3 is a block diagram illustrating components of a system having a language for expressing security policies with dynamic expression evaluation in an embodiment. A computing system 300 comprises components as illustrated and described above in relation to FIG. 1. The host services component 114 of the computing system may load security policy documents from a database 302. The database may be stored as a part of the computing system or may be stored in another computing system (not shown) that is coupled to the computing system via, e.g., an intranet or the Internet (also not shown). Any of a variety of standard database formats or vendors may be used. As an example, a security system may use MICROSOFT SQL SERVER. Alternatively, the database may be a custom database designed for a security system as described here. The contents of the database may be stored in XML form. The database may store a variety of information, including policy documents. The policy language describing a policy document may be expressed in XML using a policy schema. The policy schema is described in greater detail below in relation to FIG. 4. The database may be queried by a security engine when, e.g., a security expression is evaluated dynamically. As an example, a rule may indicate that a list of “allowed” applications is to be checked dynamically. When a rule indicates such dynamic encryption, a SQL query may be provided. A security engine may query the database with the provided SQL query. Alternatively, the security engine may request the host services component to perform the query and return an indication of the query's results to the security engine. In an embodiment, the host services component may provide an indication of “True” or “False” to the security engine as an evaluation of an expression.

The computing system may be coupled to a directory server 304 via an intranet or the Internet (coupling not shown). In an embodiment, a dynamic evaluation of a security expression may query the directory server. A directory server is a computing device that provides a directory service. A directory service provides information relating to resources of a network, such as IP addresses of computing devices coupled to the network associated with the directory server. An example of a directory service is MICROSOFT ACTIVE DIRECTORY. An administrator of a network may, e.g., desire that some users using a set of selected computing devices can send and receive messages using a set of network ports. They may make this indication to the directory service. In such a case, the administrator may create a dynamic query to determine the users and computing devices that may send or receive messages using the set of network ports. Then, when a security enforcement event occurs relating to one of the ports (e.g., when a message is sent or received), the security engine may determine its IP address and presently logged-on user, and then query the directory service to determine whether the logged-on user is authorized to send or receive messages on the port using the computing device associated with the determined IP address.

While only a database and directory server are illustrated, in actuality any dynamic security expression may be indicated for evaluation using the languages for expressing security policy documents. As examples, an expression may require dynamic evaluation of a computing system's registry, status or versions of files, available hardware, logged-on users, connected clients, and so on.

FIG. 4 is a block diagram illustrating a security policy document in an embodiment. The security policy document comprises a policy information segment 402, software resources segment 404, definitions segment 406, a first application scope segment 408 and a second application scope segment 414.

The policy information segment may comprise information relating to the security policy document (e.g., “header” information). The policy information segment may also comprise schema references that are used to validate the language of the policy document. As an example, the policy information segment may comprise the following schema reference:

| | |
|---|---|
| <policy | xmlns=“urn:mako-schema:m2:policy” |

xmlns:bb=“urn:mako-schema:m2:policy:bb”
xmlns:xsi=“http://www.w3.org/2001/XMLSchema-

instance”

xsi:schemaLocation=“urn:mako-schema:m2:policy

policy.xsd urn:mako-schema:m2:policy:bb bb.xsd”

id=“{00000000-0000-0000-0000-000000000000}”
schemaversion=“1.0”
version=“1”>

The policy information segment may additionally comprise other information relating to the policy security document. As an example, the policy information segment may comprise the following information:

<header>

<name>NetworkPolicy</name>
<description>Policies relating to network

access</description>

<company>MyCompany</company>
<copyright>2004</copyright>
<creationtimestamp>2004-12-17T09:30:47-

05:00</creationtimestamp>

<lastupdatetimestamp>2004-12-17T09:30:47-

05:00</lastupdatetimestamp>
</header>

The software resources segment may comprise a list of software resources known to the security system or that could be used later in the security policy. As an example, the software resources segment may list a number of known applications, provide an identifier for each (or a subset), indicate a location where the application can be found, and provide indications relating to a digital signature used to digitally sign an executable file associated with the application. The following example lists two known applications, App1 and App2:

<Applications>

<AppID id=“App1”>

<Location=“//AppServer/AppShare/App1Folder/”>
<Signature Signer=“Microsoft”

PublicKey=“A9FD64E12C”>

</AppID>
<AppID id=“App2”>

<Location=“//AppServer/AppShare/App2Folder/”>
<Signature Signer=“Microsoft”

PublicKey=“BA0E75F23D”>

</AppID>

</Applications>

The definitions segment may comprise data definitions that may be referenced by rules of a security policy. Data definitions can be static or dynamic. As an example, a $BAD_APPS indicator may be defined as comprising applications TROJAN.EXE and INFECTED.EXE. In this example, $BAD_APPS is a static definition. A dynamic definition may comprise an indication of how to obtain data. As an example, the $BAD_APPS indicator may contain a SQL query such as “SELECT APP_NAME FROM APP_TABLE WHERE APP_INDICATOR=‘BAD.’”The SQL query indicates to retrieve a list of applications (APP_NAME) from a table named APP_TABLE whenever an application in the table is indicated as “bad” in an APP_INDICATOR column. When a rule references this $BAD_APPS indicator, a security engine (or host services component) may request a database (e.g., MICROSOFT SQL SERVER) to perform this SQL query. Once the dynamic definition is received, a security engine may treat the values no differently than if the $BAD_APPS indicator was defined statically.

Definitions may have a variety of attributes and elements. An attribute is an indication of information that is identified with a definition. As an example, in <BannedApplications id=“1”>, “id” is an attribute of a “BannedApplications” definition. Commonly used attributes may be “id,” “version,” “persist,” “objecttype,” and “modifiable.” An id attribute may be used with a globally unique identifier (“GUID”) to uniquely identify a definition. A version attribute may be used to identify a version number of the definition, and may be incremented whenever the definition is modified so that components that reference the definition would know to refresh any copy of the definition they make. A persist attribute may be a Boolean indicator for whether the definition should be persisted (i.e., stored) to disk by the host services component. An objecttype attribute may indicate whether the definition is static or dynamic. A modifiable attribute may be used to indicate whether the definition may be modified using a user interface relating to policies (not shown).

An element is an identifier that has an association with a definition. As an example, “<Application id=“Appl”/>” is an element of “BannedApplications” having an “id” attribute in:

<BannedApplications id=“1”>

<Application id=“App1”/>

</BannedApplications>

Elements of definitions comprise a name and description. The name identifies the element and the description describes it. As an example, a banned application list may be defined by the following:

<bannedapplications id=“ {9dd514d3-f5cb-4270-a4b5-
c1b0894bc73d}” version=“0” persist=“1”
objecttype=“dynamic” modifiable=“1”>

<name>BannedApps</name>
<description>List of banned

applications</description>

<eventlevel>0</eventlevel>
<processsetref>{00000000-0000-0000-0000-

000000000017}</processsetref>
</bannedapplications>

The definitions segment may comprise a variety of data definitions. A data definition may indicate lists of banned or blessed applications. Lists of banned or blessed applications may comprise “eventlevel” and “processsetref” elements. An eventlevel element may indicate when a system event should be generated when a banned application causes a security enforcement event. An administrator e.g., may check system events to monitor whether a computing device is performing satisfactorily. As an example, a system event may be indicated for a banned application that attempts to format a hard disk but not for a banned application that attempts to use a network port. A processsetref element may comprise a list of applications that are not authorized to be loaded. The processsetref element may contain an identifier from the definitions segment that identifies a set of applications (e.g., $BAD_APPS).

A data definition may indicate a collection of files (“fileset”). A fileset may comprise file, filequery, and filesetref elements. The file element may identify a set of file names or locations, and may include wild cards that are used to match patterns or portions of names or locations. The file element may have a “recursive” attribute to indicate that contents of subfolders of identified locations should also be included. The filequery element may be used to identify a query to use when identifying a list of files. As an example, a SQL or WQL query may be used to identify a set of files. When a query is used, an objecttype attribute may be set to dynamic, as mentioned above. The filesetref element may indicate other filesets whose union defines the fileset of the definition. As an example, the fileset may comprise a file element that lists a number of files or locations canonically, a filequery element that queries a set of files dynamically, and a fileset containing the indicator $BAD_APPS (as that indicator is defined above). The fileset would then be a collection of files indicated by all three elements. Zero, one, or more instances of the elements may be associated with a fileset.

A data definition may indicate a collection of operations to be performed on files (“fileopset”). The fileopset definition may comprise a “fileop” element. The fileop element may indicate an operation including, e.g., Create, Delete, Rename, or Write. The fileopset definition may be used, e.g., by a rule to perform an operation on a file or collection of files.

In an embodiment, a data definition may comprise definitions relating to folders (or directories) and operations on directories (e.g., Create, Delete, Rename, Traverse, Modify Attributes).

In an embodiment, a data definition may comprise definitions relating to registries, such as for identifying registry keys, creating registry keys, retrieving values from registry keys, setting values of registry keys, identifying types of registry keys, and performing other operations on registries (e.g., deleting, writing, and renaming). The definitions may support dynamic selection by using queries.

In an embodiment, a data definition may comprise a collection of processes (“processset”). The processset definition may comprise a collection of processes (e.g., applications or other software resources). Each identified process additionally comprises attributes indicating a name, a version number, an indication of whether it was digitally signed, and a location where the process can be found. The processset may additionally comprise processquery and processsetref elements, which may define a query to dynamically determine a collection of processes or determine processes from other processsets, respectively. When these elements are indicated, the processset may be a union of the determined processes. In an embodiment, a data definition may comprise a processopset definition that identifies a set of operations to be performed on processes. As examples, a processopset definition may indicate to create, terminate, or suspend processes, modify a process's attributes, debug a process, or read from or write to a process's virtual memory.

In an embodiment, a data definition may comprise definitions relating to users. As an example, a user definition may be indicated for a collection of users. Users may be represented by identifier from, e.g., a directory service such as MICROSOFT ACTIVE DIRECTORY. Alternatively, users may be identified dynamically by querying the directory service using, e.g., a SQL query. The user definition may also be identified by reference to other user definitions. Thus, a collection of users may be defined by a union of a variety of forms of representing users. In an embodiment, a data definition may identify a collection of operations relating to users. As examples, operations relating to users may include creating users, removing users, modify users' passwords, or modifying users' attributes (e.g., email address).

In an embodiment, a data definition may comprise definitions relating to networks and protocols. As an example, an application protocol may be defined by referencing its identifier and defining its parameters (e.g., network ports used, direction of messages, etc.). A networkportset definition may identify a collection of network ports (e.g., IP ports). The networkportset definition may have elements relating to port numbers, ranges, dynamic queries, and references to other networkportsets. Thus, a networkportset may be defined by a union of network ports identified by its elements.

In an embodiment, a data definition may comprise a generic set of data that does not fall into any of the categories previously indicated.

In an embodiment, when a query is indicated to dynamically determine values for a definition, the query may include an indication of a locale, timeout, and default action. The locale may indicate which locale to use, e.g., to localize retrieved values. The timeout may indicate how long to wait for results of a query. The default action may indicate an action to perform when, e.g., a query results in no values, the query could not be performed, or the query timed out.

In various embodiments, data definitions may support expressions and operators. Expressions can result in values. Operators may operate on values to determine other values.

The first application scope segment 408 and the second application scope segment 414 comprise an execution scope. As an example, the first application scope segment comprises execution scope 410 and the second application scope segment 414 comprises execution scope 416. An application scope identifies a set of rules relating to an application. A security policy document may comprise multiple application scopes. An execution scope comprises an indication of whether the rules of the application scope are to be applied globally, to a set of software resources identified by a processset definition, or by default. When the execution scope is global, the rules are applied to all software resources. When the execution scope is identified by a processset definition, the rules are applied to software resources identified by the definition. The default execution scope identifies rules that may be enforced when no rules are identified in the other execution scopes. The default execution scope may identify whether the rules are to apply to all software resources or a provided list of software resources, and whether the action is to deny or allow the request that caused the security enforcement event.

An execution scope can have protection scopes. Execution scope 410 has a protection scope 412. Execution scope 416 has a protection scope 420.

The rules are then identified (within each application scope) in rule sets. Rule sets are groups of rules that may be targeted at a security engine. Each rule may comprise an identifier, name, description, conditions, actions, and exceptions. A rule comprises expressions. A rule may be semantically expressed as “IF conditions THEN actions EXCEPT exceptions.” Conditions of a rule are an expression of circumstances under which security enforcement actions of the rule could be performed, and may be static or dynamic. A static condition is one which, e.g., refers to a provided list. A dynamic condition is one which, e.g., performs a query. An action comprises activities that a security engine enforcing the rule may perform. The action may not be performed, e.g., when the true condition is listed as an exception. Other rule constructs are also possible. As an example, an else construct could be added to perform alternate actions when a condition is false. The rules may contain logical operations such as “or,” “and,” and “not.” The following is an example of a rule with conditions, an allow action, and an exception that allows application with ID 1 that performs a file operation with ID 3 unless its process has ID 55:

<rule id=“1”>

<conditions>

<if>

<and>

<file operator=“memberof”

dataId=“{00000000-0000-0000-0000-000000000001}”/>

<fileop operator=“memberof”

dataId=“{00000000-0000-0000-0000-000000000003}”/>

</and>

</if>

</conditions>
<action>

<allow/>

<action>
<exceptions>

<processexception>

<process>{00000000-0000-0000-0000-
000000000055}</process>

</processexception>

</exceptions>

In an embodiment, the security policy document may contain, e.g., a “banned” software resources list (i.e., a list of software resources that may not perform some or any tasks), a “blessed” software resources list (i.e., a list of software resources that may perform a set of tasks), a set of rules relating to specific software resources, a set of rules relating to all software resources, and a set of rules relating to unspecified (e.g., unknown) software resources.

In an embodiment, when specifying data, the languages may support definition of ranges and collections. As an example, when network ports 75 through 85 should be available to a set of software resources, the languages may support definition of the range. As a further example, when network ports 8080 and 8085 should be available, the languages may support inclusion of network ports, 8080 and 8085 in a collection. In an embodiment, an element of a collection comprises another collection, a single value, or a range.

In an embodiment, data may be localizable (e.g., text, dates, or other data expressed in a spoken language or format defined by an operating system). As an example, when a security policy includes a rule that prevents filenames comprising profane words, the text used to define a list of profane words may be localized into French when an operating system on which the rule is enforced has French set as its “locale.” That is, a security engine checking filenames may look for French words instead of (or in addition to) English words.

In an embodiment, the languages support an ability to specify interactions with other security engines. As an example, when a software resource attempts to use a file transfer protocol (“FTP”) to store a file on a remote server, a security engine may first enforce a security policy relating to a network port associated with FTP. The security engine may next cause another security engine to determine whether a remote filename specified by the software resource violates filename policies.

The computing device on which the languages for expressing security policies are implemented may include a central processing unit, memory, input devices (e.g., keyboard and pointing devices), output devices (e.g., display devices), and storage devices (e.g., disk drives). The memory and storage devices are computer-readable media that may contain instructions that implement the security system. In addition, the data structures and message structures may be stored or transmitted via a data transmission medium, such as a signal on a communications link. Various communications links may be used, such as the Internet, a local area network, a wide area network, or a point-to-point dial-up connection.

FIG. 1 illustrates an example of a suitable operating environment in which the languages for expressing security policies may be implemented. The operating environment is only one example of a suitable operating environment and is not intended to suggest any limitation as to the scope of use or functionality of the system. Other well-known computing systems, environments, and configurations that may be suitable for use include personal computers, server computers, hand-held or laptop devices including “smart” cellular telephones, multiprocessor systems, microprocessor-based systems, programmable consumer electronics, network PCs, minicomputers, mainframe computers, distributed computing environments that include any of the above systems or devices, and the like.

The languages for expressing security policies may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. A computer-readable medium containing a security policy, the security policy comprising:
a definitions section defining data of the security policy; and
a rules section comprising expressions relating to rules of the security policy, each rule comprising a condition and an action, wherein a security engine enforces the security policy by evaluating an expression associated with the condition, the expression specifying data of the definitions section, and causes the action to be performed when the evaluated expression of the condition is satisfied.

2. The computer-readable medium of claim 1 wherein the definitions section indicates that at least some of the data is external to a security policy document comprising the security policy.

3. The computer-readable medium of claim 2 wherein the external data is defined as a result of a query.

4. The computer-readable medium of claim 1 wherein the rules section has multiple segments.

5. The computer-readable medium of claim 4 wherein a segment is a policy information segment comprising information relating to the security policy.

6. The computer-readable medium of claim 4 wherein a segment is a definitions segment comprising data definitions.

7. The computer-readable medium of claim 4 wherein a segment is an application scope segment comprising an indication of an application and rules relating to the application.

8. The computer-readable medium of claim 7 wherein the application scope segment comprises an indication of execution scope.

9. The computer-readable medium of claim 8 wherein the execution scope is global.

10. A method for determining an order for enforcing multiple rules, the rules relating to a security enforcement event and enforced by a security engine, comprising:
determining whether the security enforcement event relates to a rule of a first scope level;
determining whether the security enforcement event relates to a rule of a second scope level; and
enforcing the event in relation to the determined scope level.

11. The method of claim 10 wherein the first scope level is an application level scope and the second scope level is an execution level scope.

12. The method of claim 11 wherein when the execution level scope is global, the rules are enforced in relation to all software resources.

13. The method of claim 11 wherein when the execution level scope is indicated to be associated with a subset of software resources, the rules are enforced in relation to the associated software resources.

14. The method of claim 11 wherein when the execution level scope is default, the rules are enforced when no rules of other execution scopes apply to the security enforcement event.

15. The method of claim 11 wherein the application level scope is checked first.

16. The method of claim 11 wherein the execution level scope is checked first.

17. The method of claim 10 wherein the first level is indicated in a security policy.

18. A security system for enforcing rules relating to security enforcement events, comprising:
a component that determines whether a security policy comprises a rule relating to a security enforcement event, the rule indicating a condition and action relating to the security policy enforced by the security system; and
a component that, when the rule relates to the security enforcement event, performs a query to evaluate an expression relating to the rule.

19. The security system of claim 18 wherein the query is performed using a structured query language.

20. The security system of claim 18 wherein the query is performed using a Windows Management Instrumentation query language.

21. The security system of claim 18 wherein the query is performed by querying a registry.

22. The security system of claim 18 wherein a directory services component is queried.

23. The security system of claim 18 wherein a file system is queried.

24. The security system of claim 18 wherein the query is indicated in a definitions section of a security policy document.

25. A computer-readable medium containing a security policy document, the security policy document comprising multiple rules, the rules comprising expressions of conditions and actions, wherein at least a subset of the rules are enforced by a security engine in response to a security enforcement event associated with at least one rule of the subset of rules.

26. The computer-readable medium of claim 25 wherein the at least a subset of rules is determined by evaluating a query.

27. The computer-readable medium of claim 26 wherein the evaluation is performed before the rules are provided to the security engine.

28. The computer-readable medium of claim 27 wherein the subset of rules is defined by a protection level scope.

29. The computer-readable medium of claim 26 wherein the query uses a provider of information.

30. The computer-readable medium of claim 29 wherein the provider of information is external to a security enforcement system.

31. The computer-readable medium of claim 29 wherein the provider of information is a WINDOWS UPDATE SERVICE.

32. The computer-readable medium of claim 25 wherein the at least a subset of rules is defined by whether a software resource is installed.

33. The computer-readable medium of claim 32 wherein the subset of rules relates to the installed software resource.
